(19) United States
(12) Patent Application Publication
(10) Pub. No.: US 2025/0256480 A1
(43) Pub. Date: Aug. 14, 2025

(54) Core Material Design For A Composite Construction

(71) Applicant: The Boeing Company, Arlington, VA (US)

(72) Inventor: Nicholas Villanueva, Seattle, WA (US)

(21) Appl. No.: 18/441,173

(22) Filed: Feb. 14, 2024

(51) Int. Cl. B32B 3/12; B32B 5/02; B32B 7/12; B32B 37/12; B64C 1/00

(52) U.S. Cl. CPC B32B 3/12; B32B 5/02; B32B 7/12; B32B 37/12; B32B 2260/021; B32B 2260/046; B32B 2307/7265; B32B 2605/18; B64C 1/00; B64C 2001/0072

(57) ABSTRACT

A core material for composite construction includes a group of connected open-cornered pyramid-shaped structures. Each open-cornered pyramid-shaped structure includes a flattened rectangular-shaped top component and a plurality of rectangular-shaped side components attached to the flattened rectangular-shaped top component. A top side of each rectangular-shaped side component is attached to a corresponding side of the flattened rectangular-shaped top component. A bottom side of each rectangular-shaped side component is attached to another open-cornered pyramid-shaped structure.

### FIELD

The present disclosure generally relates to a composite construction, and more particularly, to a core material design for a composite construction.

### BACKGROUND

This background description is provided for the purpose of generally presenting the context of the disclosure. Unless otherwise indicated herein, material described in this section is neither expressly nor impliedly admitted to be prior art to the present disclosure or the appended claims.

During a typical composite construction process, a core material having a honeycomb design is used to bind different materials together. The honeycomb design has inherent drawbacks. For example, a core material having the honeycomb design is relatively hard to bend in multiple directions. To illustrate, if one side of the core material bends in one direction, the other side of the core material may bend in an opposite direction. As a result, it may be relatively difficult to perform a composite construction process for curved surfaces, such as an aircraft nose cone. Additionally, a core material having the honeycomb design may have a limited bonding area.

### SUMMARY

The present application is directed to a core material design for use in a composite construction. The core material design includes a group of open-cornered pyramids with flattened tops. The core material may be highly flexible and conformable until face sheets are adhered, at which point, the core material becomes essentially a series of interconnected rigid boxes. The open corners allow the core material to flex and conform to surfaces. Additionally, the open corners provide an egress path for moisture. The flattened tops of the open-cornered pyramids provide solid bonding for face sheets. Thus, using the core material described herein for a composite construction, as opposed to using honeycomb, creates a robust structure that is less likely to dis-bond and ties each of the walls together creating a very rigid structure once bonded.

In one aspect, the present application discloses a core material for composite construction. The core material includes a group of connected open-cornered pyramid-shaped structures. Each open-cornered pyramid-shaped structure includes a flattened rectangular-shaped top component and a plurality of rectangular-shaped side components attached to the flattened rectangular-shaped top component. A top side of each rectangular-shaped side component is attached to a corresponding side of the flattened rectangular-shaped top component. A bottom side of each rectangular-shaped side component is attached to another open-cornered pyramid-shaped structure.

In another aspect, the present application discloses a composite construction. The composite construction includes a first material, a second material, and a core material that binds the first material to the second material. The core material includes a group of connected open-cornered pyramid-shaped structures. Each open-cornered pyramid-shaped structure includes a flattened rectangular-shaped top component and a plurality of rectangular-shaped side components attached to the flattened rectangular-shaped top component. A top side of each rectangular-shaped side component is attached to a corresponding side of the flattened rectangular-shaped top component. A bottom side of each rectangular-shaped side component is attached to another open-cornered pyramid-shaped structure.

In another aspect, a method includes applying at least one adhesive to a core material. The core material includes a group of connected open-cornered pyramid-shaped structures. Each open-cornered pyramid-shaped structure includes a flattened rectangular-shaped top component and a plurality of rectangular-shaped side components attached to the flattened rectangular-shaped top component. A top side of each rectangular-shaped side component is attached to a corresponding side of the flattened rectangular-shaped top component. A bottom side of each rectangular-shaped side component is attached to another open-cornered pyramid-shaped structure. The method also includes bonding a first material to the core material via the at least one adhesive.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE DRAWINGS

A more complete understanding of embodiments of the present application may be derived by referring to the detailed description and claims when considered in conjunction with the following figures, wherein like reference numbers may refer to similar elements throughout the figures. The figures are provided to facilitate understanding of the disclosure without limiting the breadth, scope, scale, or applicability of the disclosure. The drawings are not necessarily made to scale.

FIG. 1 illustrates a first view of a core material having a flat-topped open-corner pyramid shape for a composite construction, according to an exemplary embodiment;

FIG. 2 illustrates a second view of the core material having the flat-topped open-corner pyramid shape for the composite construction, according to an exemplary embodiment;

FIG. 3 illustrates an open-cornered pyramid-shaped component structure integrated into the core material, according to an exemplary embodiment;

FIG. 4 illustrates a composite construction process using the core material having the flat-topped open-corner pyramid shape, according to an exemplary embodiment; and

FIG. 5 is a flowchart of an example of an implementation of a method, according to an exemplary embodiment.

### DETAILED DESCRIPTION

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

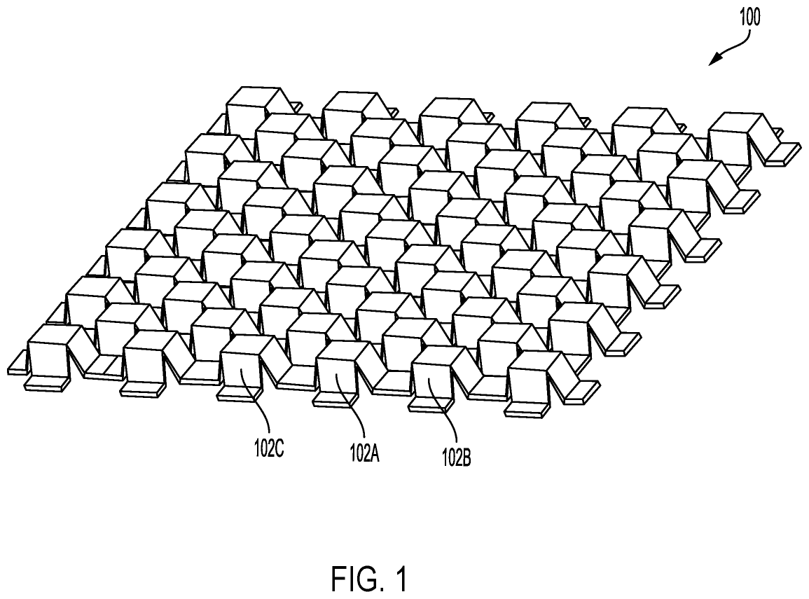

Particular implementations are described herein with reference to the drawings. In the description, common features may be designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, open-cornered pyramid-shaped component structures are illustrated and associated with reference number 102. When referring to a particular one of the open-cornered pyramid-shaped component structures, such as the open-cornered pyramid-shaped component structure 102A, the distinguishing letter “A” is used. However, when referring to any arbitrary one of the open-cornered pyramid-shaped component structures or to the open-cornered pyramid-shaped component structures as a group, the reference number 102 may be used without a distinguishing letter.

As used herein, various terminology is used for the purpose of describing particular implementations only and is not intended to be limiting. For example, the singular forms “a,” “an,” and “the” are intended to include the plural forms as well, unless the context clearly indicates otherwise. Further, the terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

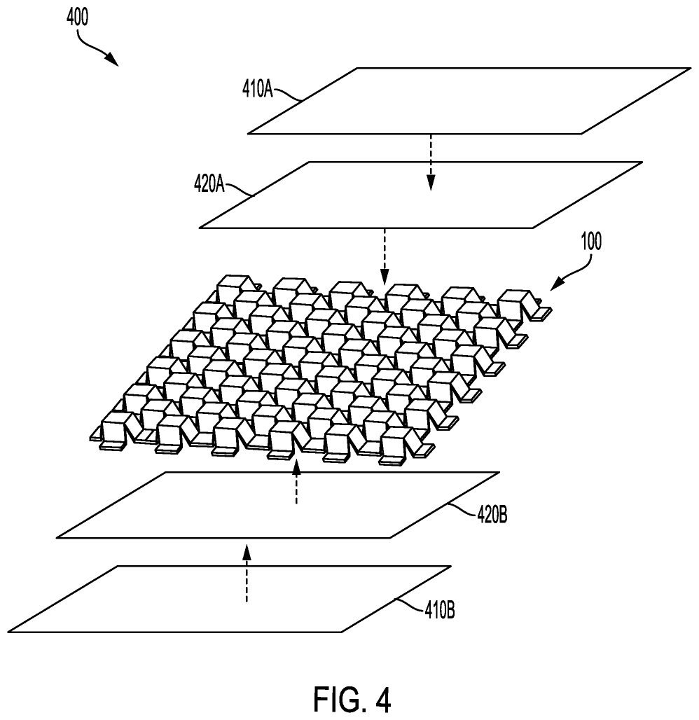

Referring to FIG. 1, a first view of a core material 100 having a flat-topped open-corner pyramid shape for a composite construction is illustrated, according to an exemplary embodiment. The core material 100 can be used to bind a first material to a second material, as described in greater detail with respect to FIG. 4. According to some implementations, the core material 100 can be used to bind different materials associated with an aircraft structure. The core material 100 may be comprised of fiber-reinforced thermoplastic.

The core material 100 includes a group of connected open-cornered pyramid-shaped structures 102. For example, as illustrated in FIG. 1, the core material 100 includes an open-cornered pyramid-shaped structure 102A, an open-cornered pyramid-shaped structure 102B, and an open-cornered pyramid-shaped structure 102C. Although three (3) open-cornered pyramid-shaped structures 102 are labeled in FIG. 1, as illustrated in FIG. 1, the core material 100 can include additional open-cornered pyramid-shaped structures 102. As a non-limiting example, in some implementations, the core material 100 can include thousands of open-cornered pyramid-shaped structures 102.

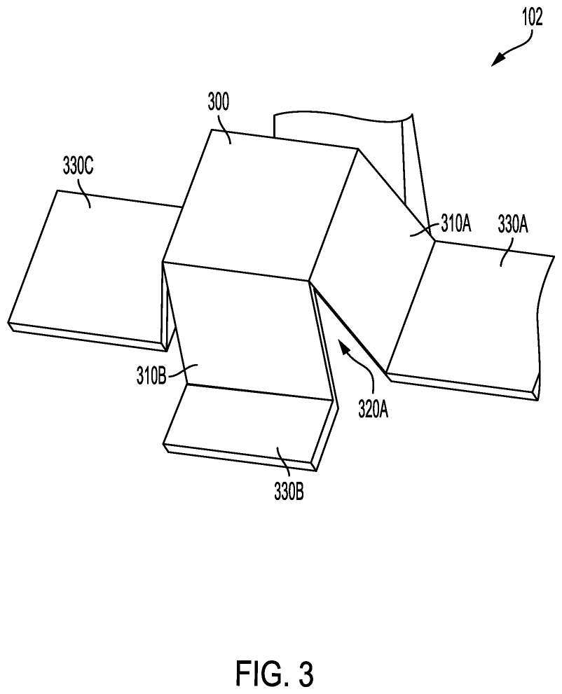

Each open-cornered pyramid-shaped structure 102 in the core material 100 can be connected to another open-cornered pyramid-shaped structure 102. For example, in FIG. 1, a bottom side of the open-cornered pyramid-shaped structure 102A is connected to a bottom side of the open-cornered pyramid-shaped structure 102B via a component of the core material 100, such as the component 330 of FIG. 3, and a bottom side of the open-cornered pyramid-shaped structure 102A is connected to a bottom side of the open-cornered pyramid-shaped structure 102C via a component of the core material 100.

As described in greater detail with respect to FIG. 3, each open-cornered pyramid-shaped structure 102 has a flattened rectangular-shaped top component and a plurality of rectangular-shaped side components that are attached to the flattened rectangular-shaped top component. A top side of the each rectangular-shaped side component is attached to (e.g., continuous with or connected to) a corresponding side of the flattened rectangular-shaped top component. A bottom side of each open-cornered pyramid-shaped structure 102 is attached to another open-cornered pyramid-shaped structure 102.

The open corners created between the flattened rectangular-shaped top component and the plurality of rectangular-shaped side components of each open-cornered pyramid-shaped structure 102, as illustrated in FIG. 1, provides an egress path for moisture in the core material 100. Additionally, the open corners enable the core material 100 to flex and conform to surfaces applied to the core material 100 during composite construction. The flattened tops of the open-cornered pyramid-shaped structure 102 provide solid bonding for face sheets. Thus, using the core material 100 described with respect to FIG. 1 for a composite construction, as opposed to using honeycomb, creates a robust structure that is less likely to dis-bond and ties each of the walls together creating a very rigid structure once bonded.

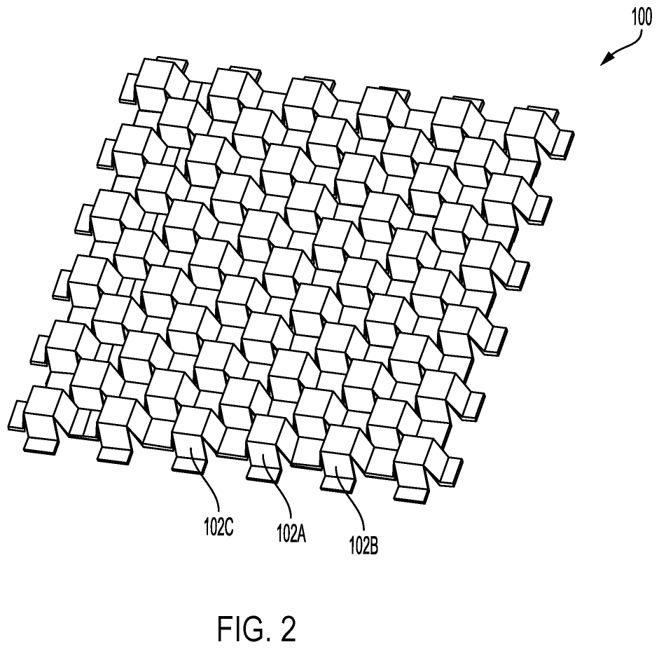

Referring to FIG. 2, a second view of the core material 100 having a flat-topped open-corner pyramid shape for a composite construction is illustrated, according to an exemplary embodiment. As illustrated from the second view in FIG. 2, the core material 100 includes the group of connected open-cornered pyramid-shaped structures 102.

Referring to FIG. 3, an open-cornered pyramid-shaped component structure 102 integrated into the core material 100 is illustrated, according to an exemplary embodiment. The open-cornered pyramid-shaped component structure 102 illustrated in FIG. 3 can correspond to the open-cornered pyramid-shaped component structure 102A of FIGS. 1-2, the open-cornered pyramid-shaped component structure 102B of FIGS. 1-2, the open-cornered pyramid-shaped component structure 102C of FIGS. 1-2, or any other open-cornered pyramid-shaped component structure of the core material 100 depicted in FIGS. 1-2.

The open-cornered pyramid-shaped component structure 102 includes a flattened rectangular-shaped top component 300. The open-cornered pyramid-shaped component structure 102 also includes a plurality of rectangular-shaped side components 310 attached to (e.g., continuous with) the flattened rectangular-shaped top component 310. For example, as illustrated in FIG. 3, the open-cornered pyramid-shaped component structure 102 includes a rectangular-shaped side component 310A attached to a first side edge of the flattened rectangular-shaped top component 300, a rectangular-shaped side component 310B attached to a second side edge of the flattened rectangular-shaped top component 300, and two more rectangular-shaped side component attached to the other two side edges of the flattened rectangular-shaped top component 300. Thus, as illustrated in FIG. 3, a top side of each rectangular-shaped side component 310 is attached to a corresponding side of the flattened rectangular-shaped top component 300.

A bottom side of each rectangular-shaped side component 310 is attached to (e.g., continuous with) another open-cornered pyramid-shaped structure. For example, a bottom side of the rectangular-shaped side component 310A is attached to a component 330A that connects with another open-cornered pyramid-shaped component structure 102, a bottom side of the rectangular-shaped side component 310B is attached to a component 330B that connects with another open-cornered pyramid-shaped component structure, a bottom side of the rectangular-shaped side component (not shown) on the left side of the open-cornered pyramid-shaped component structure 102 is attached to a component 330C that connects with another open-cornered pyramid-shaped component structure, etc. Based on the design of the core material 100, the component 330 can correspond to a flattened rectangular-shaped top component 300 if the core material 100 is viewed from an opposite side.

As depicted in FIG. 3, to create an open corner 320A as depicted in FIG. 3, a corner of a first top side of a first rectangular-shaped side component 310A contacts a corner of a second top side of a second rectangular-shaped side component 310B, and a corner of a first bottom side of the first rectangular-shaped side component 310A fails to contact a corner of a second bottom side of the second rectangular-shaped side component 310B. The other open corners of the open-cornered pyramid-shaped component structure 102 are created in a similar manner. The open corners 320 provide an egress path for moisture in the core material 100. The open corners 320 also enable the core material 100 to flex and conform to surfaces applied to the core material 100 during composite construction.

FIG. 4 illustrates a composite construction process 400 using the core material having the flat-topped open-corner pyramid shape, according to an exemplary embodiment.

According to the composite construction process 400, an adhesive 420 is applied to the core material 100. For example, as illustrated in FIG. 4, an adhesive 420A is applied to a first side of the core material 100, and an adhesive 420B is applied to a second side of the core material 100. On the first side of the core material 100, the adhesive 420A can be applied to the flattened rectangular-shaped top components 300 of the open-cornered pyramid-shaped component structures 102. Similarly, on the second side of the core material 100, the adhesive 420B can be applied to the flattened rectangular-shaped top components 300 of the open-cornered pyramid-shaped component structures 102.

According to the composite construction process 400, a first material 410A is bonded to the first side of the core material 100 via the adhesive 420A, and a second material 410B is bonded to the second side of the core material 100 via the adhesive 420B.

Thus, the flattened rectangular-shaped top components 300 of the open-cornered pyramid-shaped component structures 102 provide solid bonding for face sheets (e.g., the materials 410A, 410B). Using the core material 100 for the composite construction process 400, as opposed to using honeycomb, creates a robust structure that is less likely to dis-bond and ties each of the walls together creating a very rigid structure once bonded.

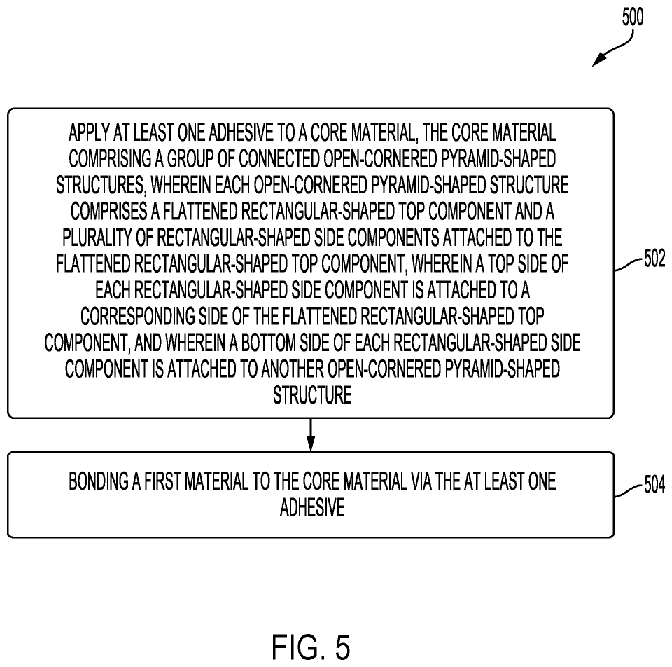

FIG. 5 illustrates a flow chart of a method 500, according to an exemplary embodiment.

The method 500 includes applying at least one adhesive to a core material, at block 502. The core material includes a group of connected open-cornered pyramid-shaped structures. Each open-cornered pyramid-shaped structure includes a flattened rectangular-shaped top component and a plurality of rectangular-shaped side components attached to the flattened rectangular-shaped top component. A top side of each rectangular-shaped side component is attached to a corresponding side of the flattened rectangular-shaped top component, and a bottom side of each rectangular-shaped side component is attached to another open-cornered pyramid-shaped structure. For example, referring to FIGS. 1-4, the adhesive 420A is applied to the core material 100. The core material 100 includes a group of connected open-cornered pyramid-shaped structures 102. Each open-cornered pyramid-shaped structure 102 includes a flattened rectangular-shaped top component 300 and a plurality of rectangular-shaped side components 310 attached to the flattened rectangular-shaped top component 300. A top side of each rectangular-shaped side component 310 is attached to a corresponding side of the flattened rectangular-shaped top component 300, and a bottom side of each rectangular-shaped side component 310 is attached to another open-cornered pyramid-shaped structure 102.

The method 500 also include bonding a first material to the core material via the at least one adhesive, at block 504. For example, referring to FIG. 4, the material 410A is bonded to the core material 100 via the adhesive 420A.

According to one implementation of the method 500, the adhesive 420A is applied on the flattened rectangular-shaped top component 300.

According to one implementation, the method 500 also includes bonding a second material to the core material via the at least one adhesive. For example, referring to FIG. 4, the material 410B is bonded to the core material 100 via the adhesive 420B.

The method 500 of FIG. 5 creates an improved composite construction. For example, the open corners created between the flattened rectangular-shaped top component 300 and the plurality of rectangular-shaped side components 310 of each open-cornered pyramid-shaped structure 102 provides an egress path for moisture in the core material 100. Additionally, the open corners enable the core material 100 to flex and conform to the materials 410 applied to the core material 100 during composite construction. The flattened tops of the open-cornered pyramid-shaped structure 102 provide solid bonding for face sheets. Thus, using the core material 100 for a composite construction, as opposed to using honeycomb, creates a robust structure that is less likely to dis-bond and ties each of the walls together creating a very rigid structure once bonded.

Although the systems are described herein with specific reference to aircraft systems or aerospace vehicles, in other embodiments, the system can be a vehicle other than an aircraft without departing from the essence of the present disclosure.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

While the systems and methods of operation have been described with reference to certain examples, it will be understood by those skilled in the art that various changes can be made and equivalents can be substituted without departing from the scope of the claims. Therefore, it is intended that the present methods and systems not be limited to the particular examples disclosed, but that the disclosed methods and systems include all embodiments falling within the scope of the appended claims.

1. A core material for composite construction, the core material comprising:
a group of connected open-cornered pyramid-shaped structures, wherein each open-cornered pyramid-shaped component structure comprises:
a flattened rectangular-shaped top component; and
a plurality of rectangular-shaped side components attached to the flattened rectangular-shaped top component, wherein a top side of each rectangular-shaped side component is attached to a corresponding side of the flattened rectangular-shaped top component, and wherein a bottom side of each rectangular-shaped side component is attached to another open-cornered pyramid-shaped structure.

2. The core material of claim 1, wherein a corner of a first top side of a first rectangular-shaped side component of the plurality of rectangular-shaped side components contacts a corner of a second top side of a second rectangular-shaped side component of the plurality of rectangular-shaped side components.

3. The core material of claim 2, wherein a corner of first bottom side of the first rectangular-shaped side component fails to contact a corner of a second bottom side of the second rectangular-shaped side component.

4. The core material of claim 1, wherein open corners of the group of connected open-cornered pyramid-shaped structures provides an egress path for moisture in the core material.

5. The core material of claim 1, wherein open corners of the group of connected open-cornered pyramid-shaped structures enables the core material to flex and conform to surfaces applied to the core material during composite construction.

6. The core material of claim 1, wherein the group of connected open-cornered pyramid-shaped structures is comprised of fiber-reinforced thermoplastic.

7. A composite construction comprising:
a first material;
a second material; and
a core material that binds the first material to the second material, the core material comprising:
a group of connected open-cornered pyramid-shaped structures, wherein each open-cornered pyramid-shaped component structure comprises:
a flattened rectangular-shaped top component; and
a plurality of rectangular-shaped side components attached to the flattened rectangular-shaped top component, wherein a top side of each rectangular-shaped side component is attached to a corresponding side of the flattened rectangular-shaped top component, and wherein a bottom side of each rectangular-shaped side component is attached to another open-cornered pyramid-shaped structure.

8. The composite construction of claim 7, wherein a corner of a first top side of a first rectangular-shaped side component of the plurality of rectangular-shaped side components contacts a corner of a second top side of a second rectangular-shaped side component of the plurality of rectangular-shaped side components.

9. The composite construction of claim 8, wherein a corner of first bottom side of the first rectangular-shaped side component fails to contact a corner of a second bottom side of the second rectangular-shaped side component.

10. The composite construction of claim 7, wherein open corners of the group of connected open-cornered pyramid-shaped structures provides an egress path for moisture in the core material.

11. The composite construction of claim 7, wherein open corners of the group of connected open-cornered pyramid-shaped structures enables the core material to flex and conform to a surface of the first material or a surface of the second material.

12. The composite construction of claim 7, wherein the group of connected open-cornered pyramid-shaped structures is comprises of fiber-reinforced thermoplastic.

13. The composite construction of claim 7, wherein the first material and the second material are associated with an aircraft structure.

14. The composite construction of claim 7, wherein the first material is bonded to the core material via an adhesive on the flattened rectangular-shaped top component.

15. A method comprising:
applying at least one adhesive to a core material, the core material comprising:
a group of connected open-cornered pyramid-shaped structures, wherein each open-cornered pyramid-shaped component structure comprises:
a flattened rectangular-shaped top component; and
a plurality of rectangular-shaped side components attached to the flattened rectangular-shaped top component, wherein a top side of each rectangular-shaped side component is attached to a corresponding side of the flattened rectangular-shaped top component, and wherein a bottom side of each rectangular-shaped side component is attached to another open-cornered pyramid-shaped structure; and
bonding a first material to the core material via the at least one adhesive.

16. The method of claim 15, wherein the adhesive is applied on the flattened rectangular-shaped top component.

17. The method of claim 15, further comprising bonding a second material to the core material via the at least one adhesive.

18. The method of claim 15, wherein a corner of a first top side of a first rectangular-shaped side component of the plurality of rectangular-shaped side components contacts a corner of a second top side of a second rectangular-shaped side component of the plurality of rectangular-shaped side components.

19. The method of claim 18, wherein a corner of first bottom side of the first rectangular-shaped side component fails to contact a corner of a second bottom side of the second rectangular-shaped side component.

20. The method of claim 15, wherein the group of connected open-cornered pyramid-shaped structures is comprised of fiber-reinforced thermoplastic.
